(19) United States
(12) Patent Application Publication
(10) Pub. No.: US 2016/0216596 A1
(43) Pub. Date: Jul. 28, 2016

(54) SLIDE-ABLE MOUNT FOR AN IMAGE DEVICE

(71) Applicant: Rhino Camera Gear, LLC, Puyallup, WA (US)

(72) Inventor: Kyle Hart, Puyallup, WA (US)

(73) Assignee: Rhino Camera Gear, LLC, Puyallup, WA (US)

(21) Appl. No.: 15/088,342

(22) Filed: Apr. 1, 2016

Related U.S. Application Data
(63) Continuation-in-part of application No. 13/974,311, filed on Aug. 23, 2013, now Pat. No. 8,721,199.
Application No. 13/974,311 is a continuation-in-part of application No. 13/947,220, filed on Jul. 22, 2013, now Pat. No. 8,858,098.
Application No. 13/947,220 is a continuation-in-part of application No. 29/457,283, filed on Jun. 7, 2013, now Pat. No. D748640.
Application No. 29/457,283 is a continuation-in-part of application No. 14/976,134, filed on Dec. 21, 2015.

(51) Int. Cl. G03B 17/56; F16M 11/18; F16M 11/04

(52) U.S. Cl. CPC G03B 17/561; F16M 11/043; F16M 11/18

(57) ABSTRACT

A camera slider system that supports a camera for longitudinal sliding. The camera sliding system comprises a pair of longitudinal rail members and a carriage system. The rail members are spaced at a substantially constant distance apart. The carriage system further comprises of a base plate upon which a camera mounting plate is fixed, along with a pair of wheel support assemblies. Each wheel support assembly engages the corresponding rail member to support longitudinal movement. Each wheel assembly further comprises of three rollers, wherein two rollers engage the interior surface of the corresponding rail member, and one roller engages the exterior surface of the same rail member. The arrangement of rollers is coplanar with the plane of the rail members. The exterior roller of each wheel assembly is adjustable relative to the corresponding rail member to accommodate any flaw in the rail profile.

### PRIORITY CLAIM

The present application is related to and/or claims the benefits of the earliest effective priority date and/or the earliest effective filing date of the below-referenced applications, each of which is hereby incorporated by reference in its entirety, to the extent such subject matter is not inconsistent herewith, as if fully set forth herein:

(1) this application constitutes a continuation-in-part of U.S. patent application Ser. No. 13/974,311, entitled SLIDE-ABLE MOUNT FOR AN IMAGE DEVICE, naming Kyle Hart as inventor, filed Aug. 23, 2013, with attorney docket no. RHNO-1-1003-1, which is currently co-pending or is an application of which a currently co-pending application is entitled to the benefit of the filing date;

(2) this application constitutes a continuation-in-part of U.S. patent application Ser. No. 13/947,220, entitled SLIDE-ABLE MOUNT FOR AN IMAGE DEVICE, naming Kyle Hart as inventor, filed Jul. 22, 2013, with attorney docket no. RHNO-1-1001-1, which is currently co-pending or is an application of which a currently co-pending application is entitled to the benefit of the filing date;

(3) this application constitutes a continuation-in-part of U.S. patent application Ser. No. 29/457,283, entitled SLIDABLE MOUNT FOR AN IMAGE DEVICE, naming Kyle Hart as inventor, filed Jun. 7, 2013, with attorney docket no. RHNO-1-1002-1, which is currently co-pending or is an application of which a currently co-pending application is entitled to the benefit of the filing date; and

(4) this application constitutes a continuation-in-part of U.S. patent application Ser. No. 14/976,134, entitled SLIDE-ABLE MOUNT FOR AN IMAGE DEVICE, naming Kyle Hart as inventor, filed Dec. 21, 2015, with attorney docket no. RHNO-1-1004-1, which is currently co-pending or is an application of which a currently co-pending application is entitled to the benefit of the filing date.

### FIELD OF THE INVENTION

The present invention relates to a camera slider system comprising a carriage system arranged to support a camera device thereon for movement along a pair of longitudinal rail members. More particularly, the present invention relates to a camera slider system in which the carriage system further comprises of a plurality of adjustable track rollers that allow the carriage system to operate smoothly over a flaw in a rail member profile.

### SUMMARY

This invention relates generally to moveable camera slider systems, and more particularly, to a camera slider system for low profile camera mountings that enables longitudinal and/or rolling movement. The present invention comprises of a pair of longitudinal rail members, which are spaced at a substantially constant distance apart, and a carriage system. The carriage system further comprises of a camera mounting plate upon which a camera is mounted; and, a pair of wheel support assemblies, which support the carriage system on the rail members. Each wheel support assembly further comprises of three track rollers, which engage the adjacent corresponding rail member. The three track rollers are disposed in a triangular planar arrangement, coplanar with the two rail members wherein two track rollers engage the interior surface of a corresponding rail member and the third track roller engages the exterior surface of the same rail member. The exterior track rollers are laterally adjustable relative to each corresponding rail member so as to accommodate any flaw in the rail member profile.

In addition to the forgoing, various other system embodiments are set forth and described in the teachings such as the text (e.g. claims, drawings, and/or the detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or other subject matter described herein will become apparent in the teachings set forth herein.

### BACKGROUND

When filming with a video camera it is common to provide a mounting system to support the camera body. Dolly and track systems allow camera operators to perform swift movements of the camera when filming moving objects and to avoid the shakiness that is inherent in moving a handheld camera. Known dolly constructions however are generally quite large and expensive.

U.S. Pat. No. 7,891,888 by Wood discloses an example of a Camera Sliding System for mounting a camera on elongated support members. The camera-mount however, is complex in configuration and lacks a means of adjusting the lateral position of the carriage track rollers relative to the rail members. The ability to adjust the track roller is advantageous when a flaw in the rail member profile is present and would inhibit the smooth movement of the carriage system over the rail members. Previous inventions have imposed strict manufacturing tolerances on the rail members to limit the possibility of inherent flaws. However, strict manufacturing tolerances lead to higher manufacturing costs, thus limiting the product's commercial appeal.

### BRIEF DESCRIPTION OF THE DRAWINGS

Embodiments of the present invention are described in detail below with the following drawings:

FIG. 1 is an isometric view of a slide-able mount for an image device, in accordance with an embodiment of the invention;

FIG. 2 is a left end side view thereof, in accordance with an embodiment of the invention;

FIG. 3 is a right end side view thereof, in accordance with an embodiment of the invention;

FIG. 4 is an isometric view of the carriage system for the slide-able mount, in accordance with an embodiment of the invention;

FIG. 5 is an isometric exploded view of the carriage system, in accordance with an embodiment of the invention;

FIG. 6 is a top plan view of the carriage system, in accordance with an embodiment of the invention;

FIG. 7 is a bottom view of the carriage system, in accordance with an embodiment of the invention;

FIG. 8 is a left end side view of the carriage system, in accordance with an embodiment of the invention;

FIG. 9 is a left side view of the carriage system, in accordance with an embodiment of the invention;

FIG. 10 is an isometric view of a slidable mount for an image device, in accordance with an embodiment of the invention;

FIG. 11 is a top view thereof, in accordance with an embodiment of the invention;

FIG. 12 is a bottom view thereof, in accordance with an embodiment of the invention;

FIG. 13 is a front view thereof, in accordance with an embodiment of the invention;

FIG. 14 is a rear view thereof, in accordance with an embodiment of the invention;

FIG. 15 is a left end view thereof, in accordance with an embodiment of the invention;

FIG. 16 is a right end view thereof, in accordance with an embodiment of the invention;

FIG. 17 is a top view of an alternate embodiment of a slide-able mount for an image device, in accordance with an embodiment of the invention;

FIG. 18 is a bottom view thereof, in accordance with an embodiment of the invention;

FIG. 19 is a left end view thereof, in accordance with an embodiment of the invention;

FIG. 20 is a right end view thereof, in accordance with an embodiment of the invention;

FIG. 21 is a bottom view of another alternate embodiment of a slide-able mount for an image device, in accordance with an embodiment of the invention; and

FIG. 22 is a diagram depicting an operational flow usable in embodiments of a slide-able mount for an image device, in accordance with an embodiment of the invention.

### DETAILED DESCRIPTION

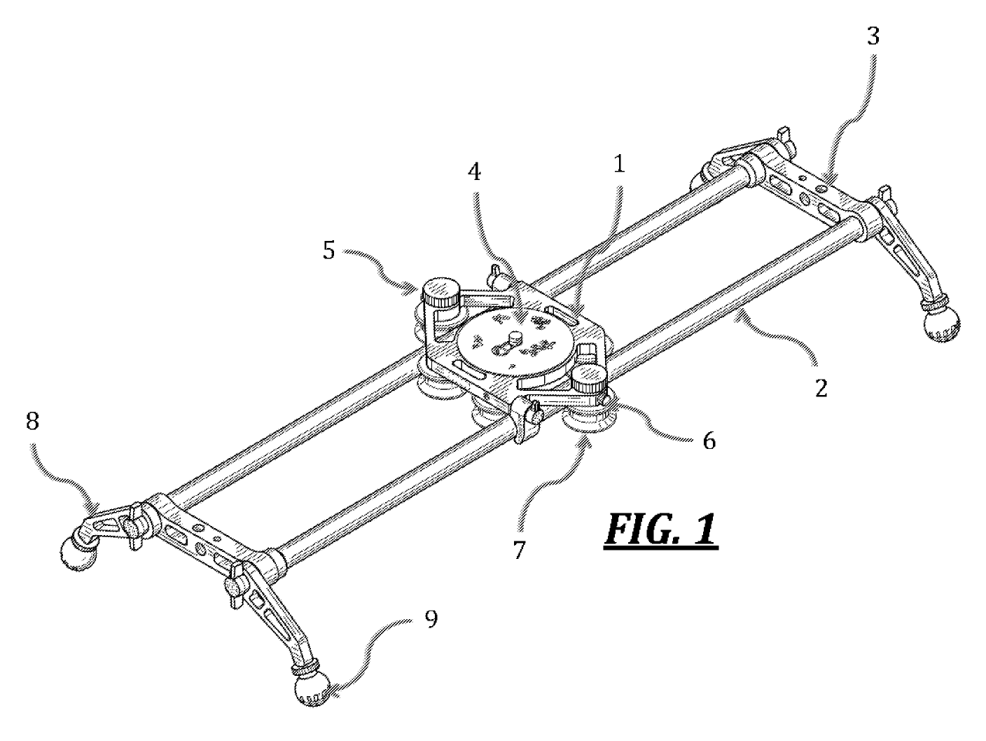

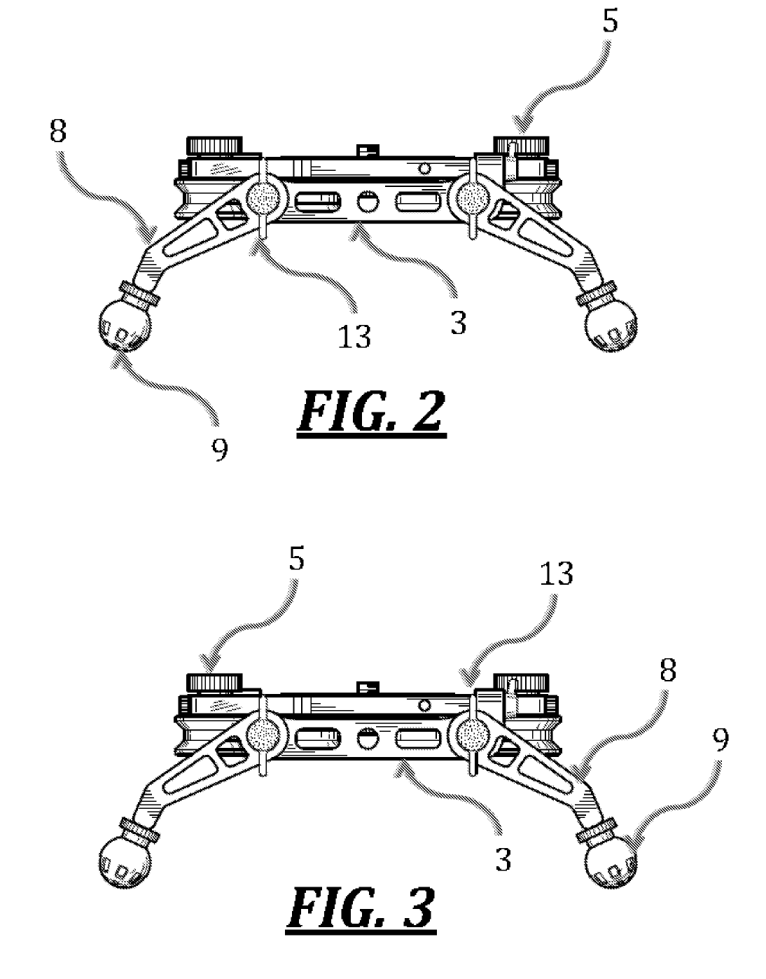

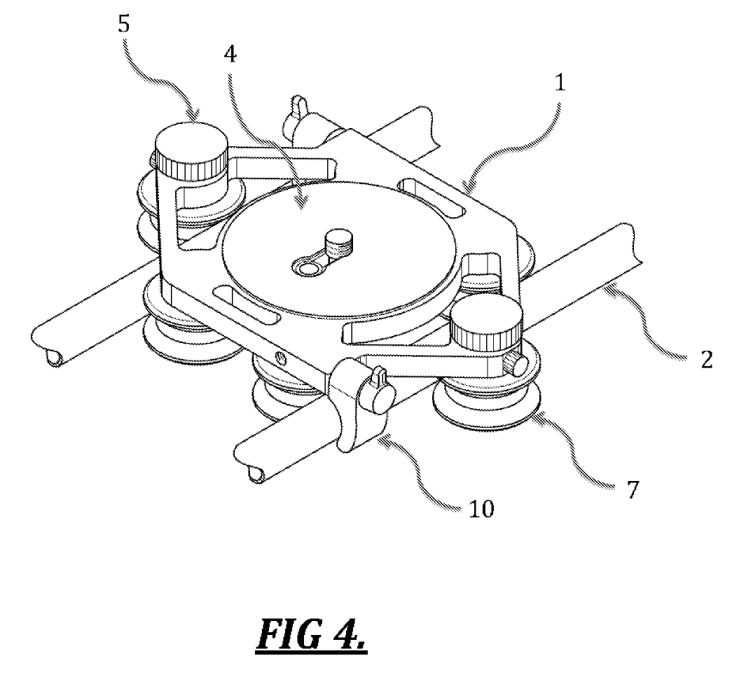

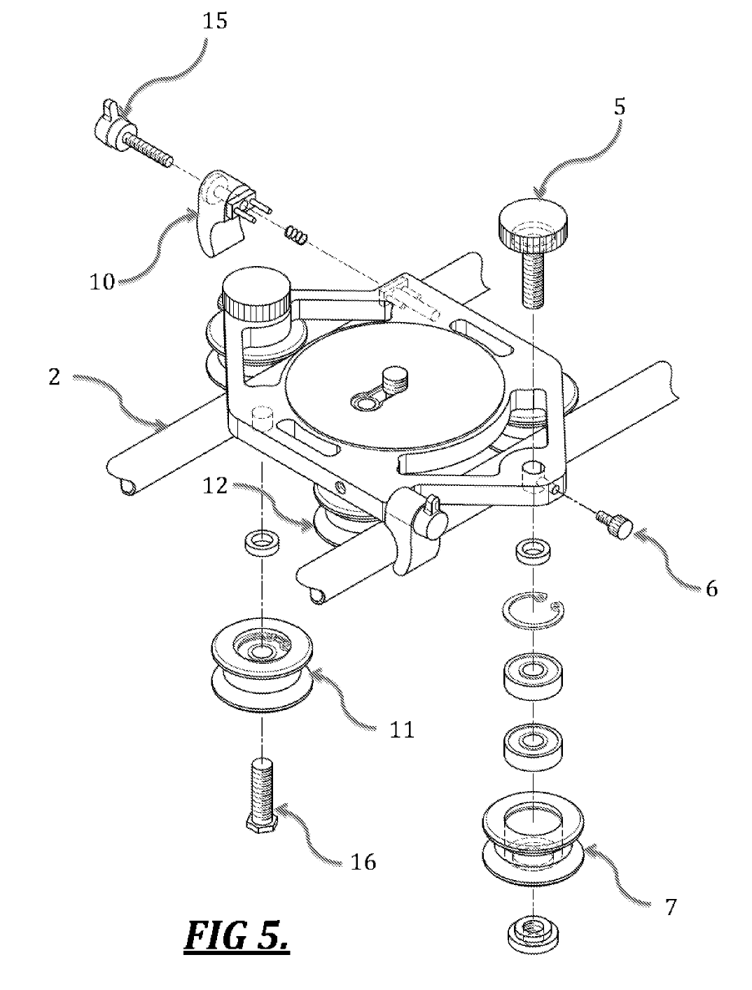

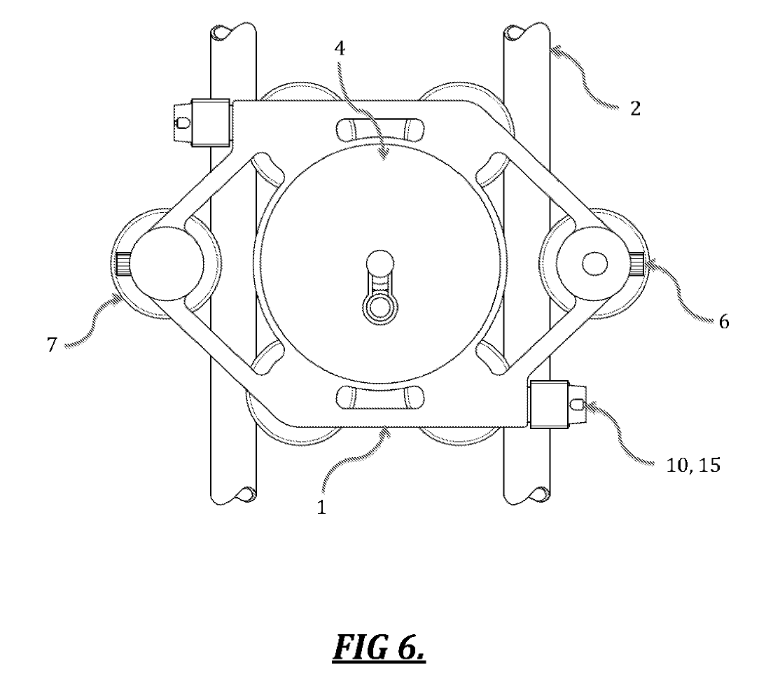

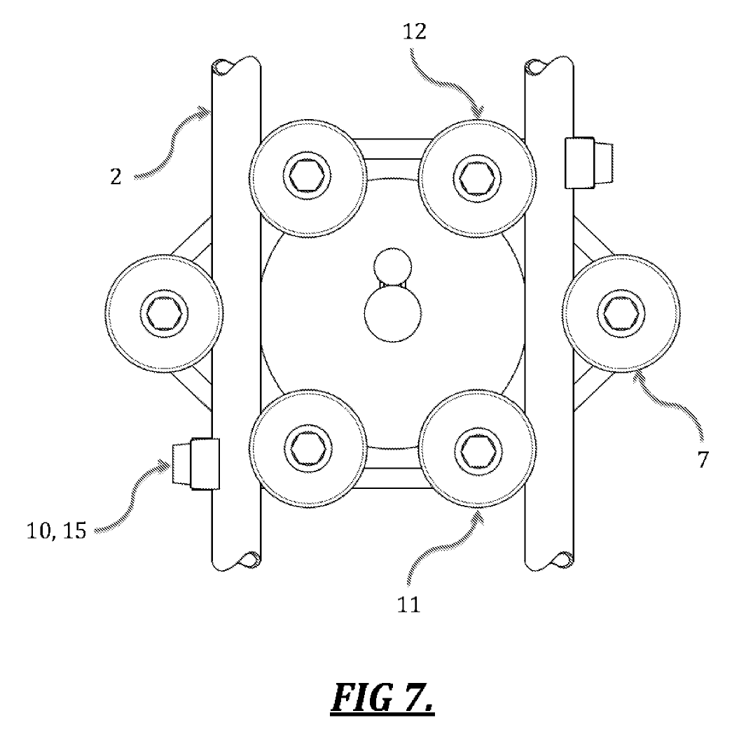

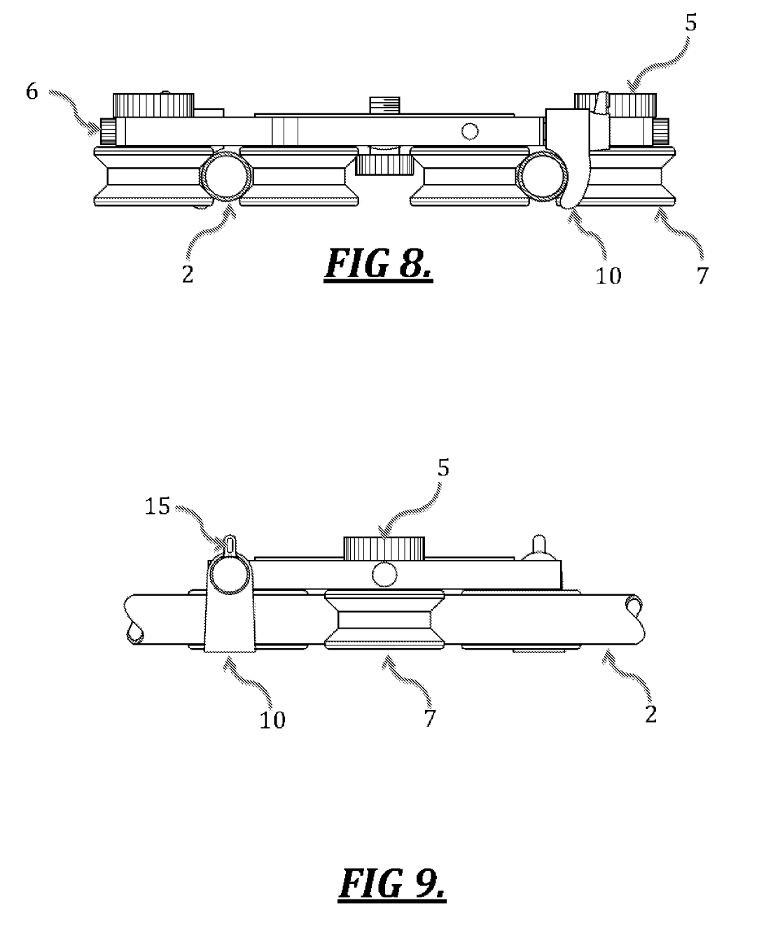

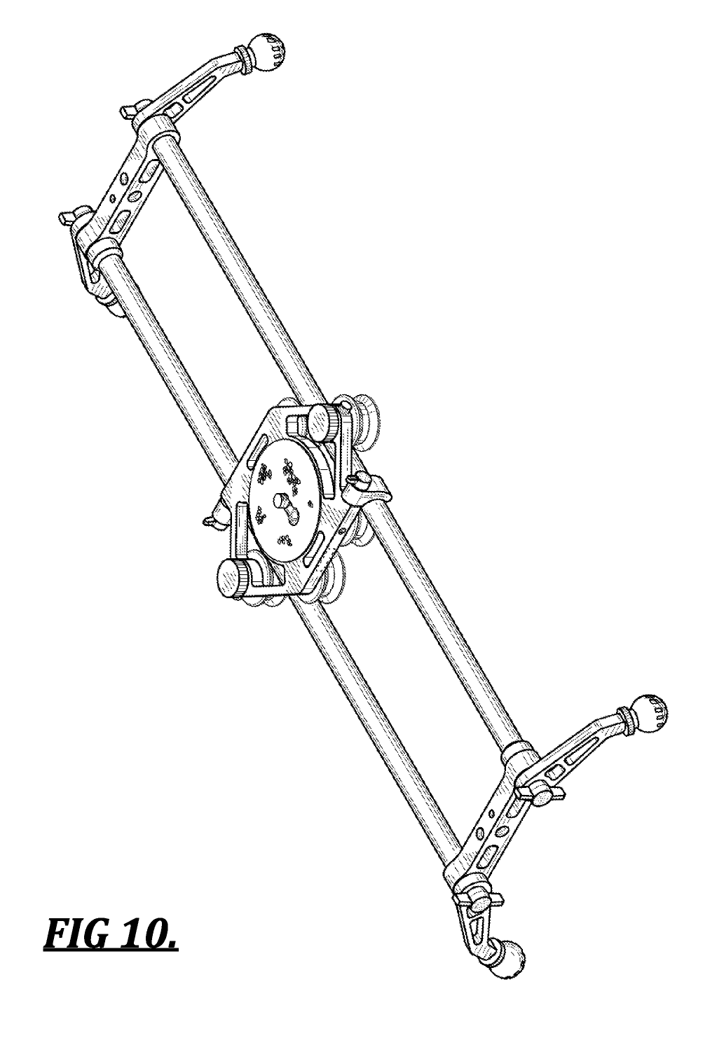

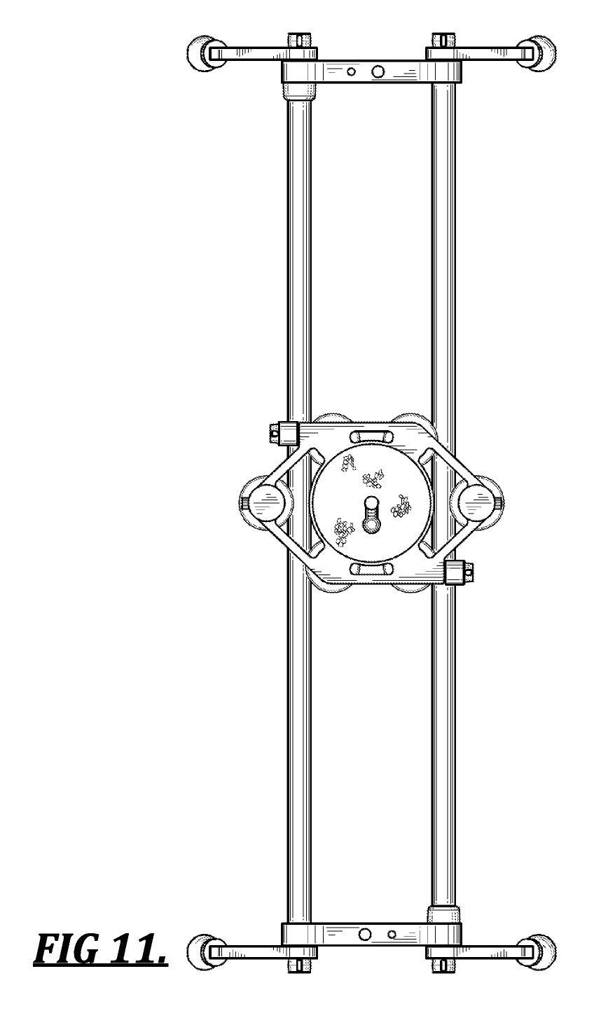

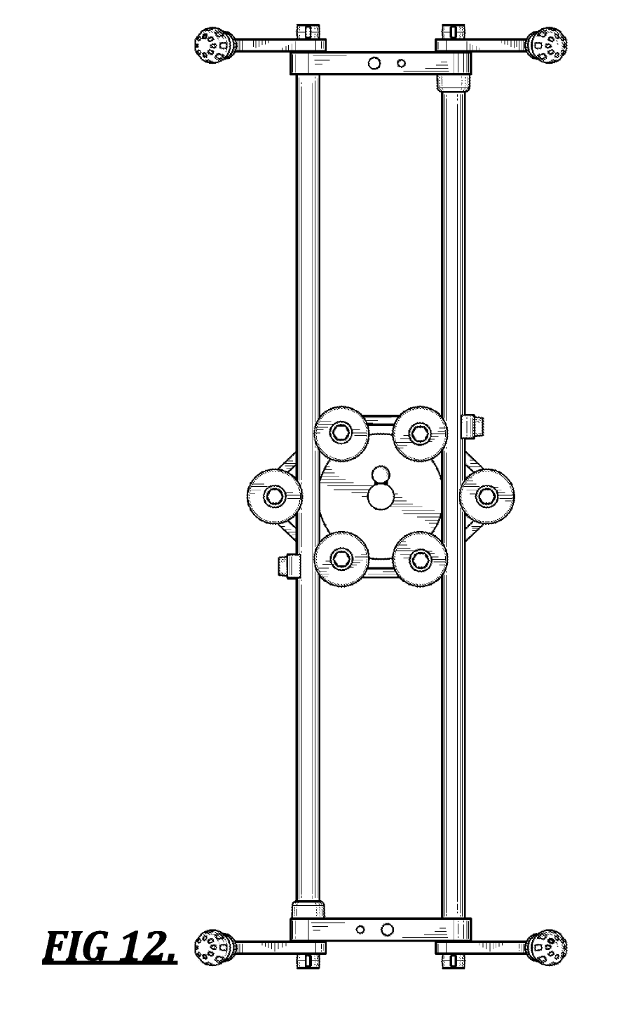

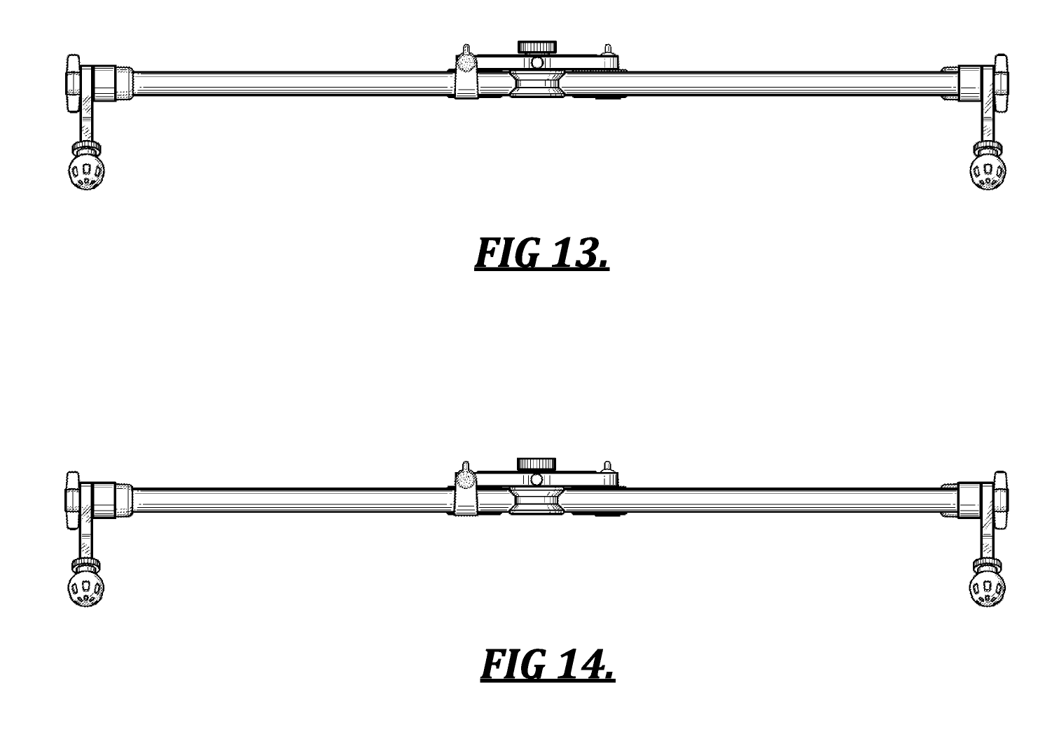

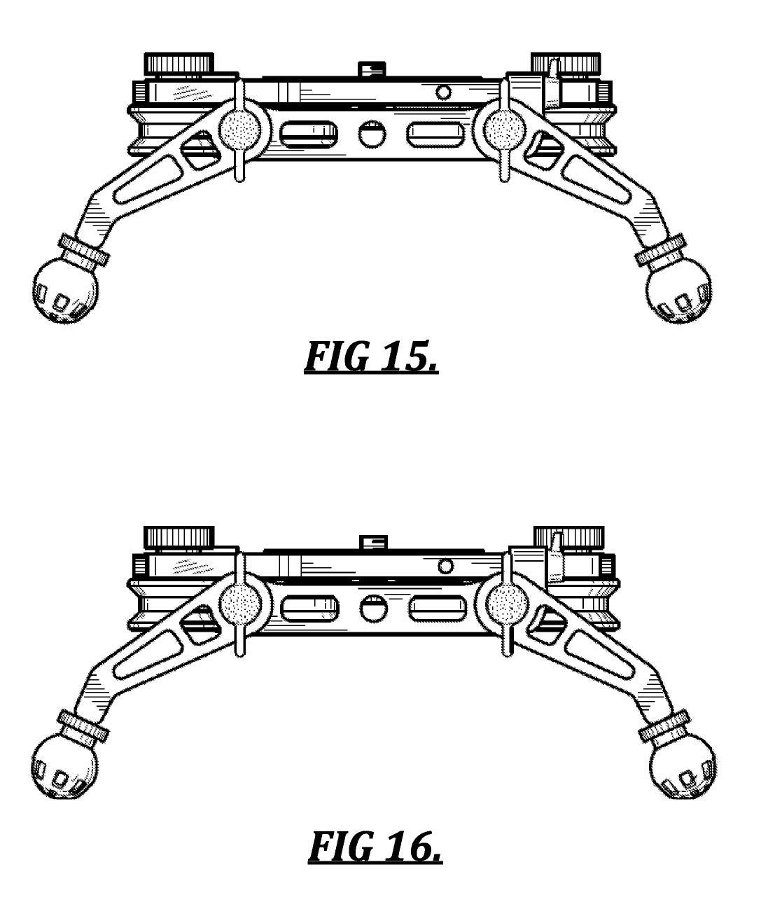

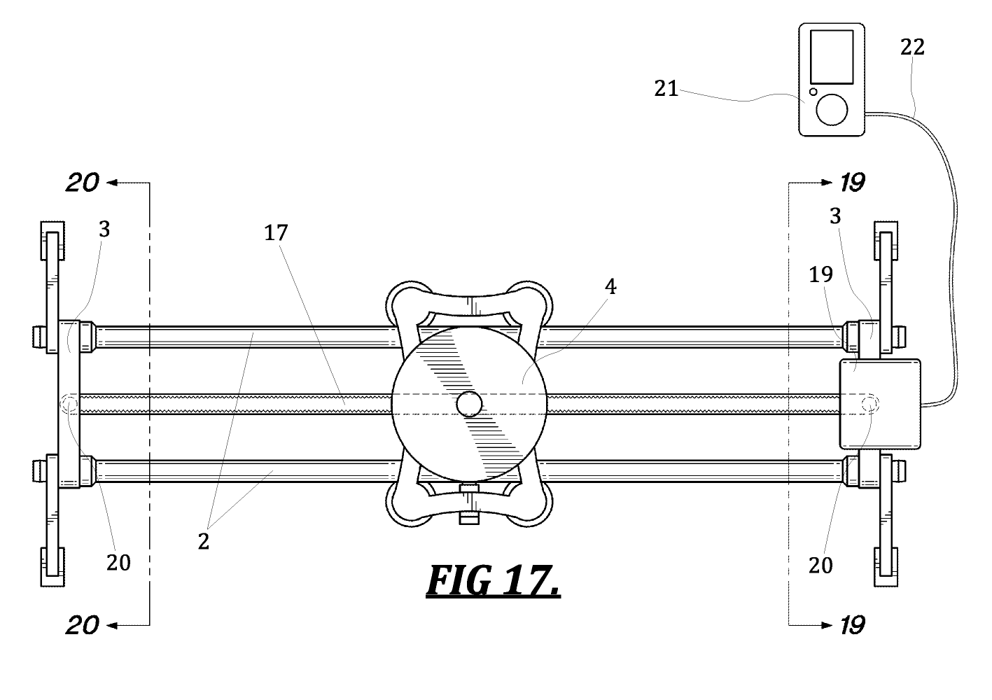

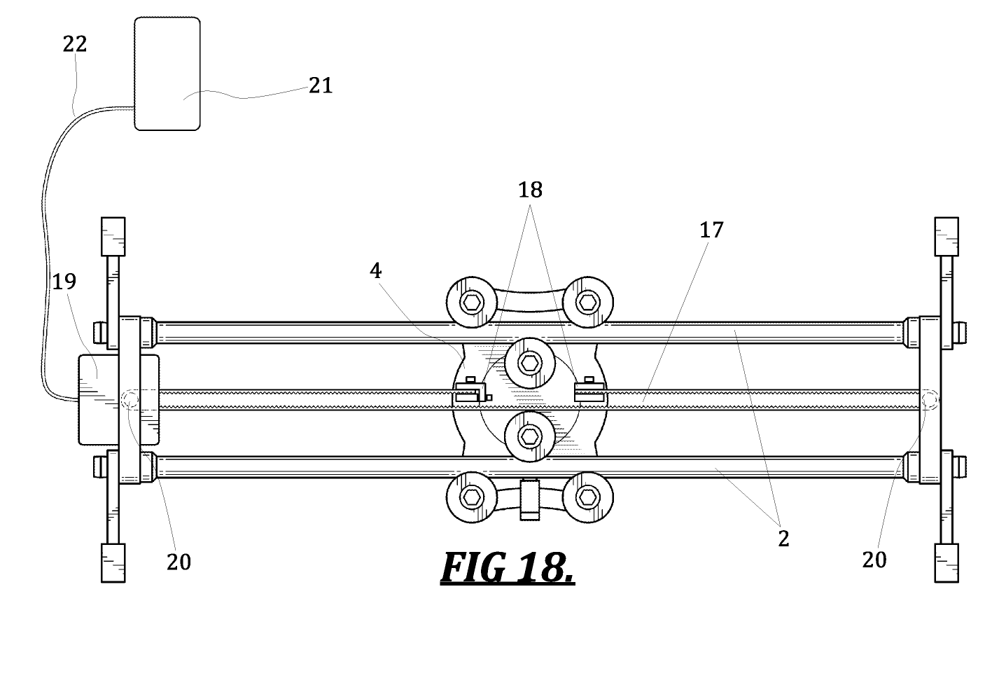

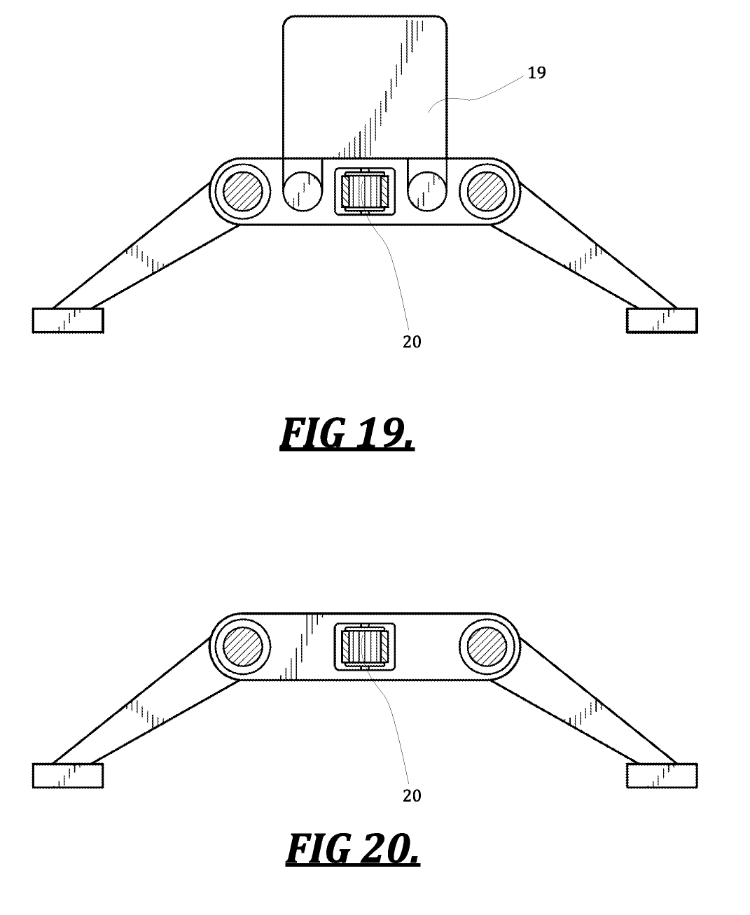

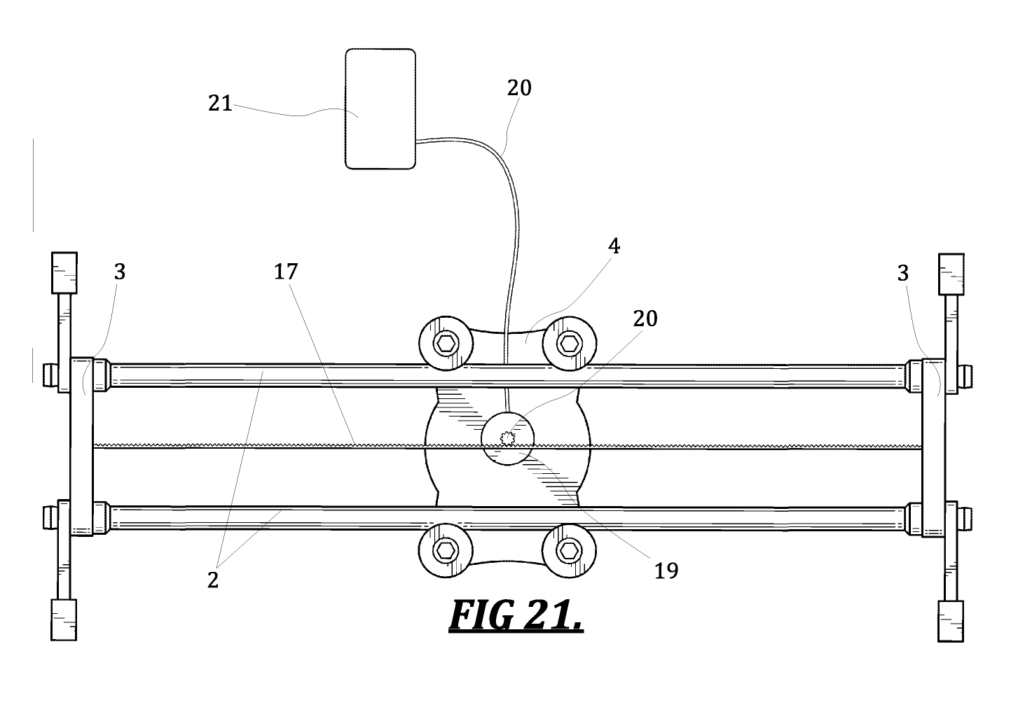

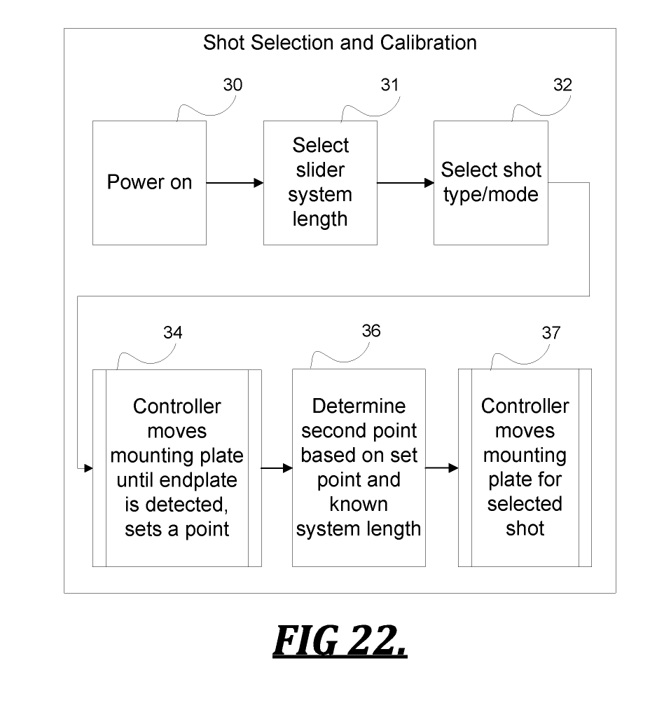

This invention relates generally to moveable slider systems for camera devices, and more particularly, to slider systems mounted on track assemblies. Specific details of certain embodiments of the invention are set forth in the following description and in FIGS. 1-22 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

The present invention provides a carriage system and track assembly configured to enable low profile camera mountings. The carriage system is configured to receive a camera device on a mounting plate, 4, and is moveable in the longitudinal direction along the track assembly. The track assembly comprises of a first and second rail member, 2. The first and second rail members, 2, are further mounted onto four pivot legs, 8, positioned at each of the four corners of the track assembly. The pivot legs, 8, allow an operator to adjust the plane of the track assembly, wherein the plane is defined by the first and second rail members, 2. The pivot legs, 8, are attached to the track assembly through an adjoining endplate, 3, and are independently adjustable in two places to allow for rotational and translational movement.

The first and second rail members, 2, are spaced at a substantially constant distance apart. The rail members, 2, are rigid rails, or rods, which extend in the longitudinal direction. In the present embodiment, the two rail members, 2, are typically straight in the longitudinal direction and have a circular cross section. In the present embodiment, the rail members are fabricated using an aluminum alloy. In another embodiment, the rail members may retain some curvature in the longitudinal direction. In yet another embodiment, the rail members may be formed using stainless steel or other stronger materials when used with heavier camera equipment. In yet another embodiment, the rail members may comprise of carbon fiber material.

In the present embodiment, to reduce the cost of manufacture, the rail members may be formed without adhering to strict manufacturing tolerances of 0.050-in or less. The ease in manufacturing tolerance is allowed by the inclusion of an adjustable track roller 7 in each wheel assembly of the carriage system. The adjustable track roller, 7, allows for lateral adjustment of the wheel assembly relative to each corresponding rail member, 2, so as to accommodate any flaw in the rail member profile such as a rail member, 2, exceeding the manufacturing tolerance of 0.050-in.

In another embodiment, the adjustable track roller may allow for lateral adjustment of the wheel assembly to accommodate a flaw in the rail member profile that exceeds a manufacturing tolerance other than 0.050-in.

In its most basic embodiment, the camera slider system comprises of a carriage system upon which a camera is mounted. The carriage system is designed to facilitate the sliding movement of the camera along the rail members, 2. The carriage system comprises of a machined base plate, 1, wherein each of the following is installed: a camera mounting plate 4, a first and second wheel-support assembly, and a first and second brake leg assembly, 10. In the present embodiment, the baseplate, 1, is machined from a single piece of aluminum. The baseplate, 1, further comprises of a plurality of openings designed to reduce the weight of the assembly.

In the present embodiment, the camera mounting plate, 4 is substantially flat to suit a fluid head camera. In another embodiment, the camera mounting plate may be substantially spherical to accommodate a 75 mm bowl.

In its most basic embodiment, the carriage system comprises of a first and second wheel support assembly that engage the corresponding first and second rail members, 2. Each wheel support assembly supports the carriage system on a corresponding rail member, 2, by the use of three track rollers, 7, 11, 12. In the present embodiment, the three track rollers 7, 11, 12, are configured in a triangular planar arrangement. Two track rollers, 11, 12, engage the interior surface of each corresponding rail member, 2, and one track-roller, 7, engages the exterior surface of the same rail member, 2. The arrangement of the three track rollers, 7, 11, 12, is coplanar with the plane of the rail members, 2. This configuration means that the entire camera slider system remains relatively compact.

In the present embodiment of each wheel support assembly, the two track rollers, 11, 12, which engage the interior surface of the rail members, 2, are fixed to the underside of the carriage system baseplate, 1, by means of a threaded fastener that is disposed through each track roller, 11, 12. Internal threads are machined into the underside of the baseplate, 1, to receive each of the two track roller fasteners, 16. The internal threads are required to ensure the top surface of the baseplate, 1, is flush to receive the camera mounting plate, 4. This arrangement ensures the carriage system remains relatively compact.

In the present embodiment of each wheel support assembly, the track roller 7 that engages the exterior surface of each corresponding rail member, 2, may be laterally displaced relative to each rail member, 2, to accommodate an inherent flaw in the rail member profile. This exterior track roller, 7, identified as the “adjustable track roller” hereafter, is installed onto the carriage system baseplate, 1, by a knurled thumbwheel, 5, which is disposed through an elongated mounting hole in the carriage system baseplate, 1. The elongated dimension of the hole is oriented in the lateral direction towards the corresponding rail member, 2, thus facilitating the lateral displacement of the adjustable track roller, 7. Tightening and loosening the knurled thumbwheel, 5, acts to increase and decrease the friction force between the adjustable track roller 7 and baseplate 1, respectively. An increase in friction force locks the lateral position of adjustable track roller 7 in place. An advantage of the present invention is that the adjustable track roller, 7, can be displaced laterally away from a flawed rail member, allowing the carriage system to move uninhibited across a flaw in a rail member profile. In addition, by moving the adjustable track roller 7 away from or towards each corresponding rail member, 2, an operator can control the speed at which the carriage system moves along the rail members. In the present embodiment, each wheel support assembly further comprises of a setscrew, 6, operable to laterally move the adjustable track roller, 7, towards the corresponding rail member, 2. Internal threads are machined into the carriage system baseplate, 1, to receive the setscrews, 6. The setscrew, 6, is positioned to interface with the centerline of the knurled thumbwheel shaft 5. The setscrew, 6, provides an additional means of moving the adjustable track roller, 7, towards the corresponding rail member, 2.

In the present embodiment, the carriage assembly further comprises of a first and second brake leg, 10, which is designed to impede the longitudinal movement of the carriage system along the rail members, 2. The brake legs, 10, are laterally disposed on the carriage system adjacent to each rail member, 2. Each brake leg, 10, is designed to impede the longitudinal movement of the carriage system by generating a friction force between the brake leg surface and the mating rail member surface. The interior surface of the brake leg, 10, is geometrically contoured to match the exterior surface of the corresponding rail member, 2. In the present invention, the interior surface of the brake leg is circular. The brake leg, 10, is operable by tightening or loosening a levered thumbwheel, 15, which secures the brake leg, 10, to the carriage system base plate, 1. Tightening the levered thumbwheel, 15, will act to move the brake leg, 10, laterally towards the corresponding rail member, 2. Once the brake leg, 10, contacts the corresponding rail member, 2, the friction between the brake leg, 10, and rail member surfaces acts to impede longitudinal movement of the carriage system. Loosening the levered thumbwheel, 15, will have the opposite effect, whereby the brake leg, 10, will move away from the rail member, 2, allowing the carriage system to move unimpeded along the rail members, 2.

In the present embodiment, the camera slider system comprises of two endplates, 3, which each connect to the common ends of the rail members, 2. The length of the endplates, 3, substantially determines the lateral spacing between the rail members, 2. Each endplate, 3, has a plurality of ⅜-inch and ¼-inch threaded holes to accommodate mounting of additional camera accessories, such as tripods. In addition, in order to receive the pivot legs, 8, the endplates, 3, and the rail members, 2, are drilled and tapped through the longitudinal axis of the rail members, 2.

In the present embodiment, the camera slider system further comprises of four pivot legs, 8, which are attached by a hinge coupling to the rail member endplates, 3. The pivot legs 8 are coupled to the endplates 3 at the endplate holes tapped through the longitudinal axis of the rail members, 2. As such, the pivot legs, 8, are designed to rotate about the longitudinal axis of each corresponding rail member, 2, which has the advantage of making the mounting assembly more compact when folded for storage. This design also reduces the cost of manufacture since the number of threaded fasteners to install the pivot legs 8 and endplates 3, is halved.

The four pivot legs 8 are independently adjustable in two places, namely at the pivot leg 8 and endplate 3 hinge coupling, and at the feet of each pivot leg. Major rotational adjustments can be made at the hinge coupling through a winged thumbwheel, 13. In the present embodiment, the pivot leg surface that mates with the rail member endplate incorporates a face gear pattern that is machined radially about the hinge-coupling axis. The endplate 3 incorporates a mating face gear pattern, machined radially about the same hinge-coupling axis. A sufficient mesh of the two gear patterns is designed to provide sufficient rotational fixity to support to the pivot leg in its prescribed rotational position. Rotational fixity of the pivot leg can be established by tightening the winged thumbwheel 13, which is disposed through hinge coupling axis between each pivot leg 8 and rail member endplate, 3. Tightening the winged thumbwheel 13 will act to clamp the pivot leg 8 against the rail member endplate 3 increasing the engagement of mating gear patterns.

Minor translational adjustments can also be made at the feet of the pivot legs 8 through a threaded ball joint assembly. In the present embodiment, a rubber ball 9 is threaded into the base of each pivot leg 8. Each rubber ball 9 incorporates a threaded stem that mates with an internal thread machined into the tip of each pivot leg. Increasing or decreasing the number of exposed threads between the pivot leg and rubber ball 9 acts to adjust the pivot leg 8 translational height.

In the present embodiment, at least one rubber bumper ring 14 is installed over each rail member 2 and is abutted against a rail member endplate 3. The rubber bumper ring 14 is required to cushion any contact between the carriage system and the rail member endplate 3 in cases where the carriage system brake is not set. In the present embodiment, one rubber bumper ring 14 is installed on diagonally opposite ends of the rail members 2 so as to cushion any carriage system contact with the rail member endplates 3 in both directions. In another embodiment, rubber bumper rings 14 may be installed at both ends of each rail member 2.

Movement of the carriage by hand can introduce jitter and/or lead to uneven movement, causing images to be blurred or causing pan shots or time-lapse shots to be disrupted or unevenly paced. Moreover, hand movement of portions of the slider system can lead to damage to the slider system or the camera equipment, especially if the mounting plate, 4, collides with an endplate, 3. For at least these reasons, some embodiments of the slider system may include one or more mechanisms for automating the movement of the slider.

In one embodiment, the mounting plate, 4, may be coupled with a gearbelt, 17, which is disposed between rail members, 2. In one preferred embodiment, mounting plate, 4, is coupled directly with gearbelt, 17, such that two ends of the gearbelt are joined with the mounting plate. See FIG. 18. Two gears, 20, are included in the system, one in each endplate, 3. Movement of mounting plate, 4, is controlled via motor, 19, which is coupled with one gear, 20. In one embodiment, gear, 20, may include a receptacle configured to accept a shaft of the motor, 19. In some embodiments, the receptacle and shaft may be square in shape. In some embodiments, the motor, 19, may be permanently coupled with the gear, 20, and in other embodiments it may be removably coupled. When engaged, the motor, 19, rotates gear 20 either clockwise or counter clockwise to move the mounting plate, 4, along the rail members, 2. It should be understood that, the gearbelt, 17, could be replaced with a chain, and the gears, 20, could be replaced with a chain wheel or sprocket without altering the function of the system.

In another preferred embodiment, the gearbelt, 17, is fixed and permanently coupled with each endplate, 3. The gear, 20, and motor, 19, are disposed on mounting plate, 4. The motor, 19, rotates the gear, 20, clockwise or counterclockwise, causing the mounting plate, 4, to move along the gearbelt, 17, in either direction.

The motor, 19, is engaged via controller, 21. In some embodiments, the controller, 21, may be coupled with the motor, 19, via a cord, 22. The corded coupling may utilize USB, Ethernet, or another wired interface. In other embodiments, the controller, 21, may be coupled with the motor, 19, via a wireless connection, such as Wi-Fi, Bluetooth® (including but not limited to Bluetooth Low Energy or Bluetooth Smart), Zigbee, or some other wireless connection. In some embodiments, the controller, 21, may be an individual unit specifically configured to work with the slider system. In other embodiments, the controller, 21, may be a multi-functional device, such as a user device like a tablet, a laptop, a mobile phone or smartphone, or another wired or wireless device, such as a Wi-Fi enabled music player, upon which a user can install a program configured to work with the slider system. In such an embodiment, at least one of the motor, 19, or the mounting plate, 4, may be coupled with a receiver configured to receive wireless communications.

Uncontrolled movement of the mounting plate, 4, may cause it to collide at a fast pace with one of the endplates, 3. Additionally, prior art motorized sliders may attempt to move the mounting plate past the endplate, causing gears to grind. In order to mitigate these risks, the present invention includes a calibration step which, during regular use, causes the mounting plate, 4, to slow prior to reaching the endplate, 3, such that the mounting plate comes to a stop in advance of a possible collision between the mounting plate and endplate.

In the instant embodiment, upon the user selecting a particular shot type, the shot begins with a calibration cycle, which is described more fully below. Once the calibration is complete, the controller, 21, can move the mounting plate, 4, according the desired shot type, without risk of damaging the equipment in a collision of the mounting plate with one of the endplates. For example, during a panning shot using the motorized slider, the completed calibration permits the carriage to automatically decelerate and smoothly come to a halt at the end of the slider, leading to smoother, more desirable panning effects.

The calibration is conducted via controller, 21, using information provided by the user at power-up and through hardware detection of a location of one or both endplates, 4. When the controller, 21, is powered on, 30, the user is asked to provide the slider system length, 31. In some embodiments the system may be pre-programmed with different types of slider systems offered by the manufacturer, each having a corresponding stored length, for selection by the user. In other embodiments, the user may enter the slider length directly.

The user may then navigate a menu to the desired mode or shot type, such as panoramic, time lapse, etc., 32. Once the user selects the shot via the menu, calibration begins. A first point is set, 34, as the controller, 21, activates the motor, 19, which engages the gear, 20, and causes the mounting plate, 4, to move slowly along the rail members, 2, until it reaches an endplate, 3, and can move no further. The inability to move further is detected by the controller, 21, using various means described below and the first point is set, 34, signifying the location of the endplate.

In some embodiments, the location of the endplate is determined when the controller, 21, detects an abrupt increase in electrical current being drawn by the motor, 19. The increase would result from the motor, 19, stalling subsequent to the mounting plate, 4, reaching the endplate, 3 (“stall current detection”). In different embodiments, the location of the endplate may be detected using a magnet and hall effect sensor combination, requiring two hall effect sensors (one on each end of the mounting plate) and two magnets (one in each endplate), whereby the mounting plate, 4, moves until the hall voltage is detected by one of the hall effect sensors, signifying the location of the endplate, 3. In other embodiments, a mechanical switch is utilized, whereby a switch is depressed when the mounting plate, 4, reaches the endplate, 3. Switches may be present on each end of the mounting plate, 4, and/or in each endplate, 3. In still other embodiments, an optical sensor may be used in conjunction with a laser or an LED, whereby activation of the optical sensor signifies the location of the endplate, 3. In other embodiments, a force sensor may be present on each end of the mounting plate, 4 and/or in each endplate, 3, whereby activation of the optical sensor signifies the location of the endplate, 3. In yet other embodiments, the slider uses a combination of any or all of the above means for detecting the location of the endplate.

Upon the controller setting the first point as described above, the controller then accesses the length of the slider system entered at 31, and uses the length to calculate the second point 36, which, in a preferred embodiment, is located at the opposite endplate, 3. In some embodiments, a user may be able to select, via the menu, a shorter movement length, in which case the second point may be located at a position along rail members, 2, other than at the point coterminous with the opposite endplate, 3. Following the completion of the calibration, the controller, 21, moves the mounting plate to provide the selected shot, 37, the shot type having been selected at 32.

In some embodiments, the controller, 21, may continue its endplate detection as a fail-safe during movements of the slider. While the calibration is intended to prevent the controller, 21, from commanding the mounting plate, 4, to move past the endplate, 3, circumstances may arise which defeat the calibration. As one non-limiting example, subsequent to the calibration the user may apply pressure to the mounting plate, 4, or the gearbelt, 17, causing the mounting plate to slip to a new position along the gearbelt such that the calibrated endplate point is no longer accurate. In this instance, the controller could attempt to move the mounting plate, 4, past the endplate, 3. Accordingly, during a move, even though a calibration cycle has been completed the controller, 21, still employs endplate detection means to prevent a collision between the mounting plate, 4, and the endplate, 3 and/or to prevent grinding of the slider gearing.

For example, for a slider which uses stall current detection to determine location of the endplate, during a move, 37, if stall current is unexpectedly detected due to the mounting plate arriving at the endplate, the controller, 21, is interrupted and the move is aborted. In other embodiments where the slider uses hall effect sensors, the controller, 21, may rely during a move on the detection of the Hall voltage to slow the mounting plate, 4, before it collides with an endplate, 3. The other means of endplate detection described above (mechanical switches, optical sensors, force sensors, etc.) may all be used as well for fail-safe means during pre-programmed movements of the slider.

Subsequent to completion of a shot, when the user performs an additional shot, calibration occurs again. Even if the controller remains powered on in between shots, the slider motor disengages so as to not stress the motor or use power unnecessarily. During such periods the carriage may be moved by hand, necessitating calibration previous to another shot. In some embodiments, calibration occurs immediately upon power-up and previous to selection of a shot type and/or mode. In some embodiments, calibration occurs immediately following completion of a slider move.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A camera slider system for supporting a camera for longitudinal movement, the system comprising:
a first endplate including at least a first gear;
a second endplate including at least a second gear;
a track assembly having a first and second rail member disposed longitudinally between the first endplate and the second endplate;
a mounting plate supported for longitudinal movement along the first and second rail members;
a gearbelt disposed between the first gear and the second gear, the gearbelt configured for movement of at least the mounting plate;
a motor interfaced with the gearbelt; and
a controller coupled with the motor, the controller configured for sensing position of the mounting plate relative to at least one of the first endplate or the second endplate.

2. The camera slider system of claim 1, wherein the controller is configured for imparting motion to the mounting plate responsive to selection of a move via a user interface of the controller.

3. The camera slider system of claim 1, wherein the controller is configured for calibration previous to imparting motion to the mounting plate in conjunction with a move selected via a user interface of the controller.

4. The camera slider system of claim 1, wherein the controller is configured for detecting a point where the mounting plate is adjacent to an endplate.

5. The camera slider system of claim 1, wherein the controller is configured for detecting a first point where the mounting plate is adjacent to the first endplate and configured for determining a second point where the mounting plate is adjacent to the second endplate at least partially based on a slider system length received at least partially via a user interface of the controller.

6. The camera slider system of claim 1, wherein the controller is configured for detecting a point where the mounting plate is adjacent to the endplate at least partially via detection of stall current.

7. The camera slider system of claim 1, wherein the controller is configured for detecting a point where the mounting plate is adjacent to the endplate at least partially via one or more hall effect sensors.

8. The camera slider system of claim 7, wherein the mounting plate includes a first hall effect sensor disposed on a first side of the mounting plate and a second hall effect sensor disposed on a second side of the mounting plate, wherein the first endplate includes a first magnet, and wherein the second endplate includes a second magnet.

9. The camera slider system of claim 1, wherein the controller is configured for detecting a point where the mounting plate is adjacent to the endplate at least partially via one or more optical means.

10. The camera slider system of claim 1, wherein the controller is configured for decelerating the mounting plate during a move upon the mounting plate approaching an endplate at least partially based on detection of a point where the mounting plate is adjacent to the endplate detected during a calibration previous to a move selected via a user interface of the controller.

11. The camera slider system of claim 1, wherein the camera slider system is configured for electronically preventing collisions between the mounting plate and an endplate.

12. The camera slider system of claim 1, wherein the controller is an application installed on a user device.

13. The camera slider system of claim 1, wherein the user device includes at least a smartphone.

14. The camera slider system of claim 1, wherein the user device includes at least a tablet computer.

15. The camera slider system of claim 1, wherein the controller is wirelessly coupled with the motor.

16. The camera slider system of claim 14, wherein the controller is wirelessly coupled with the motor via a Bluetooth connection.

17. The camera slider system of claim 1, wherein the controller includes at least one non-transitory computer-readable medium including one or more indications of one or more sliders and a corresponding one or more lengths of the one or more sliders.

18. The camera slider system of claim 1, including at least fail-safe detection of an endplate preventing the controller from commanding the mounting plate to move past the endplate.

19. A camera slider system for supporting a camera for longitudinal movement, the system comprising:
a first endplate;
a second endplate;
a track assembly having a first and second rail member disposed longitudinally between the first endplate and the second endplate;
a mounting plate supported for longitudinal movement along the first and second rail members;
means for electronically imparting the longitudinal movement along the first and second rail members of the mounting plate; and
means for preventing the means for electronically imparting the longitudinal movement from commanding movement of the mounting plate past an endplate.

20. A camera slider system for supporting a camera for longitudinal movement, the system comprising:
a first endplate including at least a first gear;
a second endplate including at least a second gear;
a track assembly having a first and second rail member disposed longitudinally between the first endplate and the second endplate;
a carriage system;
a gearbelt disposed between the first gear and the second gear, the gearbelt configured for movement of at least the carriage system;
a motor interfaced with the gearbelt; and
a controller coupled with the motor, the controller configured for sensing position of the carriage system relative to at least one of the first endplate or the second endplate.
